(19) United States
(12) Patent Application Publication
(10) Pub. No.: US 2005/0035606 A1
(43) Pub. Date: Feb. 17, 2005

(54) Handle for opening and closing shoji

(75) Inventor: Chikara Yamashita, Wesley Chapel, FL (US)

Correspondence Address: JORDAN AND HAMBURG LLP, 122 EAST 42ND STREET, SUITE 4000, NEW YORK, NY, 10168, US

(73) Assignee: Meiko of Tampa, Inc., Wesley Chapel, FL (US)

(21) Appl. No.: 10/671,020

(22) Filed: Sep. 25, 2003

(30) Foreign Application Priority Data
Aug. 11, 2003 (JP) 2003-291111

(51) Int. Cl. E05B 3/00

(52) U.S. Cl. 292/336.3

(57) ABSTRACT

A handle for opening and closing a shoji includes a pedestal fixed to the window frame side stile of a sliding door shoji; a lever handle attached to this pedestal and swingably pivoted in a predetermined angle range; a kicking-out member fixed to a shaft portion of the lever handle and projected toward the window frame side by the swinging operation of the lever handle performed by opening and operating the sliding door shoji, and assisting the opening operation of the shoji by reaction force for kicking-out the window frame; and a spring member for biasing this kicking-out member toward a projection opposing side rotating direction. Further, an auxiliary lock includes a rotatable locking hook piece in the lever handle and a receiving piece fixed to the window frame side and freely engaged with and disengaged from the locking hook piece.

### BACKGROUND OF THE INVENTION

1. Field of the Invention

The present invention relates to a handle for opening and closing a shoji and having an assist function of the opening operation and an auxiliary lock function when a sliding door shoji or a raising-lowering shoji is opened and closed.

2. Description of Related Art

Many sliding door shoji type windows are adopted as windows of general houses and buildings, etc. In the case of this sliding door shoji, a crescent lock is used as a locking device in many cases. The crescent lock is constructed by a locking side fitting having a crescent attached so as to be freely rotated and fitted to a check rail portion on the indoor shoji side, and is also constructed by a crescent receiving fitting having a hook portion engaged with the above crescent and fixed to a check rail portion on the outdoor shoji side.

On the other hand, in the windows of general houses, buildings, etc., a structure forming a double lock by adding an auxiliary lock (herein after also called a sublock) separately from the crescent lock arranged in the above check rail of the sliding door tends to be increased to improve crime preventing property. For example, as shown in FIG. 10, a structure having a stopper 52 stored so as to be freely projected and recessed by a support shaft 51 in a seesaw system within a case 50 is used as this sublock in many cases.

However, in the case of the window of a size normally generally used in the opening and closing operations of the above sliding door shoji type window, the window can be simply opened and closed by applying only force of a certain extent. However, in the case of a shoji heavy in weight such as a large-sized window arranged in entrance and exit portions to a terrace, a veranda, etc. and the window of a special large size in which a ceiling face are also set to a glass face, large force is required when the shoji is opened from the closing state of the window. Therefore, a problem exists in that considerable labor is required in the opening and closing operations.

Further, as mentioned above, the auxiliary lock is arranged separately from the main locking device to improve the crime preventing property. However, if the function as the auxiliary lock can be given to the handle for opening and closing arranged in the shoji, a triple lock mechanism can be set so that further crime preventing effects are expected.

### SUMMARY OF THE INVENTION

Therefore, a main object of the present invention is to provide a handle for opening and closing the shoji and having the assist function so as to simply open and operate the heavy shoji even by small force in the opening and closing operations of the sliding door, etc., and provide an auxiliary lock function for this handle for opening and closing the shoji.

To solve the above problems, in a first aspect of the invention, the present invention provides a handle for opening and closing a shoji, comprising a pedestal fixed to the window frame side stile of a sliding door shoji or the lower rail of a raising-lowering shoji; a lever handle attached to this pedestal and swingably pivoted in a predetermined angle range; a kicking-out member fixed to a shaft portion of the lever handle and projected toward the window frame side by the swinging operation of the lever handle performed by opening and operating the sliding door shoji, and assisting the opening operation of the shoji by reaction force for kicking-out the window frame; and a spring member for biasing this kicking-out member toward a projection opposing side rotating direction.

In the invention described in the above aspect, the kicking-out member projected toward the window frame side by the swinging operation of the swingable lever handle and assisting the opening operation of the shoji by reaction force for kicking-out the window frame is arranged. The shoji is initially moved at the opening operation time of the shoji. As is well known, the coefficient of static friction is greater than the coefficient of dynamic friction. Accordingly, if the initial movement can be first given, the coefficient of friction becomes the coefficient of dynamic friction so that the shoji can be opened and operated by small force.

In the invention according to another aspect of the invention, an auxiliary lock is constructed by arranging a rotatable locking hook piece in the lever handle, and fixing a receiving piece freely engaged with and disengaged from the locking hook piece to the window frame side.

In the invention according to another aspect of the invention, an auxiliary lock is constructed by arranging a rotatable locking hook piece on the window frame side, and forming a receiving engaging portion freely engaged with and disengaged from the locking hook piece in the lever handle.

In the invention according to another aspect of the invention, an auxiliary lock is constructed such that a locking plate slidable in the vertical direction and having a locking hook portion projected to the exterior from a side edge of the rail is arranged in the pedestal portion, and a hole portion for locking freely engaged with and disengaged from the locking hook portion by the sliding operation of the locking plate is arranged on the window frame side.

In the invention according to another aspect of the invention, an auxiliary lock is constructed such that a locking plate swung by the swinging operation of the lever handle performed by opening and operating the sliding door shoji or the raising-lowering shoji, and having a locking hook portion projected to the exterior from a side edge of the rail is arranged in the pedestal portion, and a hole portion for locking freely engaged with and disengaged from the locking hook portion by the swinging operation of the locking plate is arranged on the window frame side.

As mentioned above in detail, in accordance with the present invention, when the sliding door, etc. are opened and closed and operated, the heavy shoji can be simply opened and operated even by small force, and the auxiliary locking function is provided to this handle for opening and closing the shoji so that high crime preventing effects are expected.

### BRIEF DESCRIPTION OF THE DRAWINGS

FIG. 1 is a front view of a handle 1A for opening and closing a shoji in accordance with a first mode example.

FIG. 2 is its transversal sectional view (a view seen from the arrow line II-II of FIG. 1).

FIG. 3 is an exploded perspective view of the above handle 1A for opening and closing the shoji.

FIG. 4 is a front view of a handle 1B for opening and closing a shoji in accordance with a second mode example.

FIG. 5 is its transversal sectional view (a view seen from the arrow line V-V of FIG. 4).

FIG. 6 is an exploded perspective view of the above handle 1B for opening and closing the shoji.

FIG. 7 is a front view of a handle 1C for opening and closing a shoji in accordance with a third mode example.

FIG. 8 is its transversal sectional view (a view seen from the arrow line VIII-VIII of FIG. 7).

FIG. 9 is an exploded perspective view of the above handle 1C for opening and closing the shoji.

FIG. 10 is a view showing a conventional sublock structure.

### DESCRIPTION OF THE PREFERRED EMBODIMENTS

The embodiment modes of the present invention will next be described in detail with reference to the drawings.

### FIRST MODE EXAMPLE

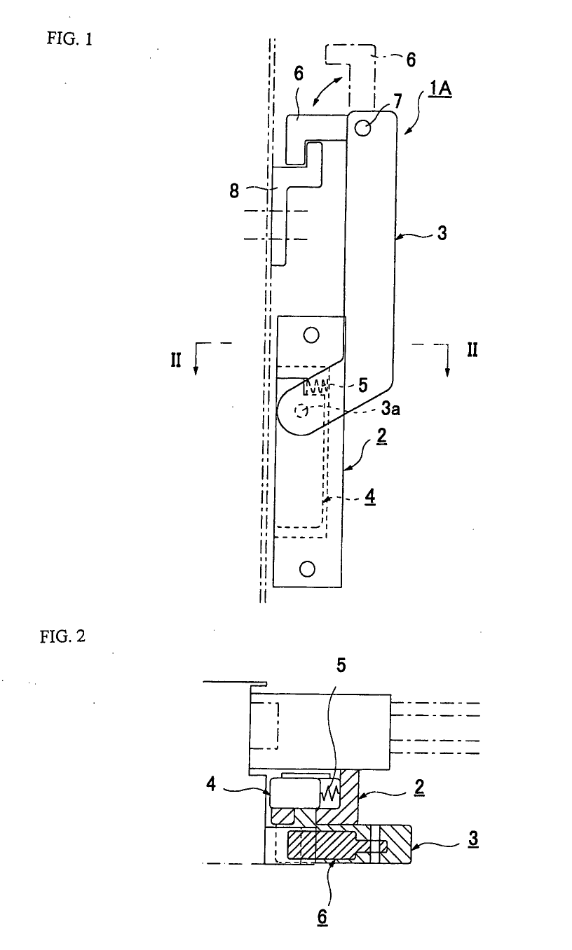

A handle 1A for opening and closing a shoji in accordance with a first mode example will be described in detail on the basis of FIGS. 1 to 3.

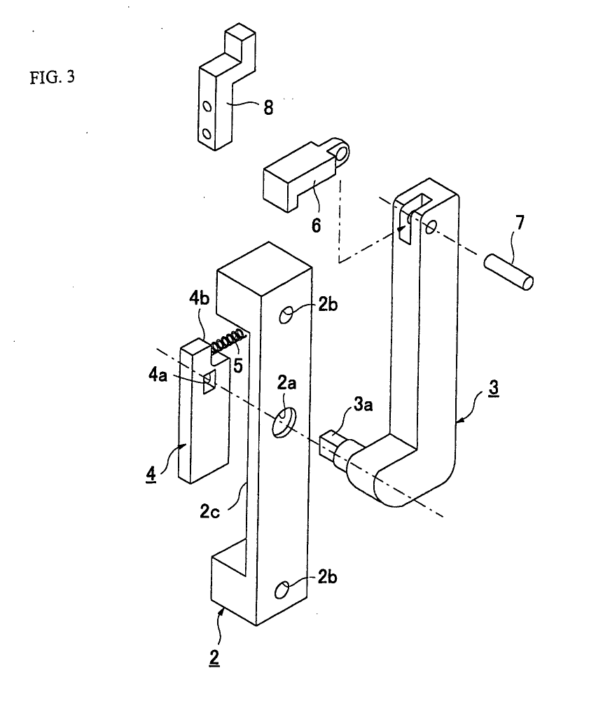

As shown in FIG. 3, the handle 1A for opening and closing a shoji is constructed by a pedestal 2, a lever handle 3, a kicking-out member 4 and a spring member 5. The pedestal 2 is fixed to the window frame side stile of a sliding door shoji. The lever handle 3 is attached to this pedestal 2 and is swingably pivoted in a predetermined angular range. The kicking-out member 4 is fixed to a shaft portion 3a of the above lever handle 3, and is projected toward the window frame side by the swinging operation of the above lever handle 3 performed by opening and operating the above sliding door shoji, and assists the opening operation of the shoji by reaction force for kicking-out the window frame. The spring member 5 biases this kicking-out member 4 toward a projection opposing side rotating direction.

The handle 1A for opening and closing a shoji will now be described concretely. The above pedestal 2 is a member of a rectangular parallelepiped shape having a storing concave portion 2c of the above kicking-out member 4 on its inner face side. Through holes 2b, 2b for fixing screws are respectively formed in the upper and lower portions of the pedestal 2. A shaft hole 2a is formed approximately in the central portion of the pedestal 2 and the shaft portion 3a of the lever handle 3 is inserted into this shaft hole 2a.

The above lever handle 3 is a gripping member having the shaft portion 3a at one end of its rotation central side. A locking hook piece 6 of an L-shape rotatably supported by a pin shaft 7 is arranged on the tip side of the lever handle 3.

A shaft hole 4a is formed on one end side of the above kicking-out member 4, i.e., on the upper end side of the kicking-out member 4 in the illustrated example. A stepwise notch portion 4b is formed in one end side corner portion of the kicking-out member 4. This kicking-out member 4 is biased toward the projection opposing side rotating direction (the rotating direction in which the kicking-out member 4 is stored to the storing concave portion 2c) by the spring member 5 arranged between the vertical wall face of this notch portion 4b and the deep face of the storing concave portion 2c of the pedestal 2.

When the handle 1A for opening and closing a shoji is assembled, the shaft portion 3a of the above lever handle is inserted into the shaft hole 2a of the pedestal 2, and the above shaft portion 3a is inserted into the shaft hole 4a of the kicking-out member 4 arranged in the storing concave portion 2c of the pedestal 2. The lever handle 3 and the kicking-out member 4 are connected to each other by extraction preventing processing such as caulking, etc. When the handle 1A for opening and closing a shoji is attached to the shoji, as shown in FIG. 1, a receiving piece 8 freely engaged with and disengaged from the locking hook piece 6 arranged in the tip portion of the above lever handle 3 is fixed to the window frame side.

In such a handle 1A for opening and closing a shoji, when the above lever handle 3 is gripped in the opening operation of the shoji and force is applied to the lever handle 3 in the opening direction of the shoji, the lever handle 3 is swung and the kicking-out member 4 is simultaneously projected to the window frame side and kicks-out the window frame so that the shoji is initially moved. Therefore, the shoji can be simply opened and operated by small force. Further, when the shoji is closed, locking can be performed by rotating the locking hook piece 6 arranged at the tip of the above lever handle 3 and engaging the locking hook piece 6 with the receiving piece 8 fixed to the window frame.

### MODIFIED EXAMPLE

(1) In the above first mode example, the rotatable locking hook piece 6 is arranged in the above lever handle 3, and the receiving piece 8 freely engaged with and disengaged from the above locking hook piece 6 is fixed to the window frame side. However, this relation may be also reversely set. Namely, the rotatable locking hook piece 6 may be also arranged on the window frame side, and an unillustrated receiving engaging portion freely engaged with and disengaged from the above locking hook piece 6 may be also formed in the above lever handle 3.

### SECOND MODE EXAMPLE

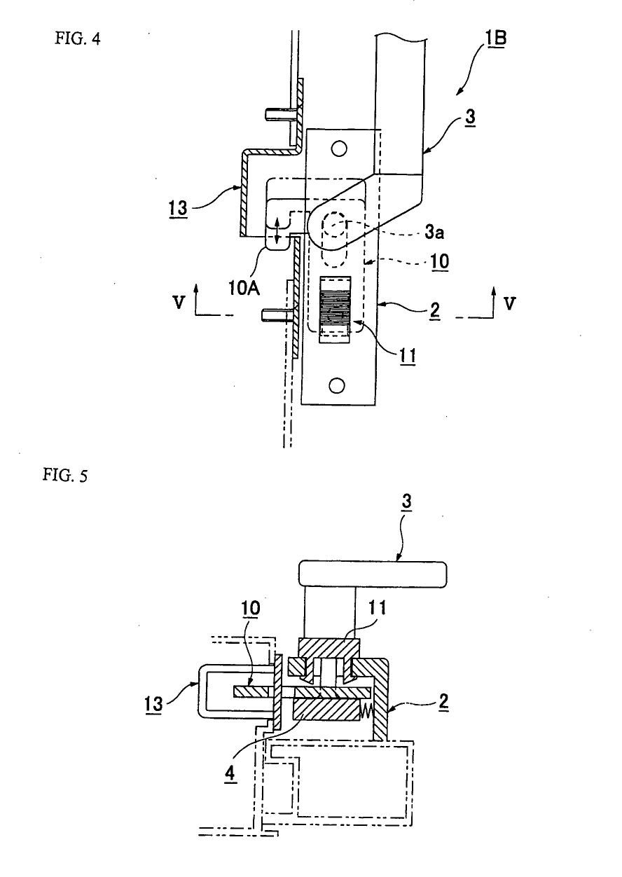

A handle 1B for opening and closing a shoji in accordance with a second mode example will next be described in detail on the basis of FIGS. 4 to 6.

Similar to the above first mode example, the basic structure of the handle 1B for opening and closing a shoji itself is constructed by a pedestal 2, a lever handle 3, a kicking-out member 4 and a spring member 5. The pedestal 2 is fixed to the window frame side stile of a sliding door shoji. The lever handle 3 is attached to this pedestal 2 and is swingably pivoted in a predetermined angular range. The kicking-out member 4 is fixed to a shaft portion 3a of the above lever handle 3, and is projected toward the window frame side by the swinging operation of the above lever handle 3 performed by opening and operating the above sliding door shoji, and assists the opening operation of the shoji by reaction force for kicking-out the window frame. The spring member 5 biases this kicking-out member 4 toward a projection opposing side rotating direction. Accordingly, with respect to the basic structure, the same reference numerals as the first mode example are designated in the drawings and their explanations are omitted.

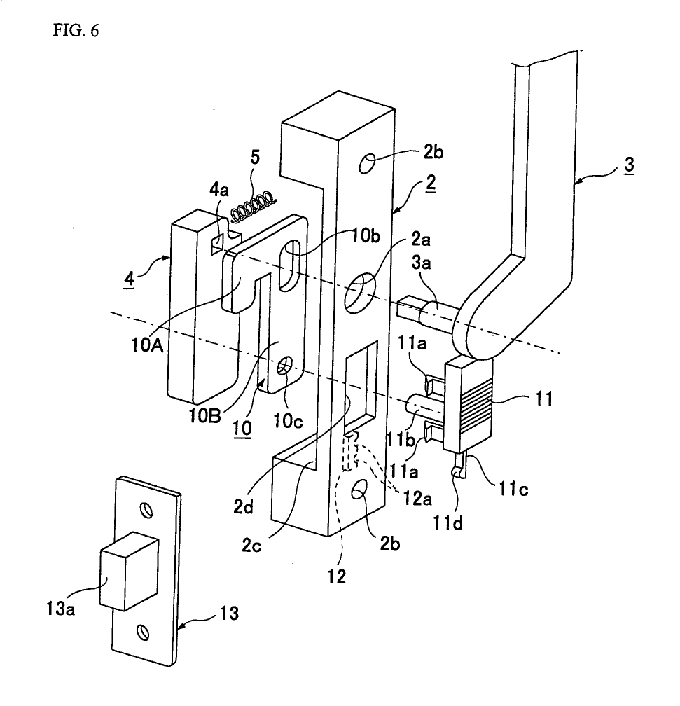

This second mode example differs from the first mode example in the structure of an auxiliary lock. As shown in FIG. 6, the auxiliary lock is constructed such that a locking plate 10 slidable in the vertical direction and having a locking hook portion 10A projected to the exterior from the side edge of the stile is arranged in the above pedestal portion 2, and a hole portion for locking able to be engaged with and disengaged from this locking hook portion 10A by the sliding operation of the above locking plate 10 is formed on the window frame side.

The handle 1B for opening and closing a shoji will next be described concretely. The above locking plate 10 is a plate member constructed by a main body plate portion 10B and the locking hook portion 10A projected to the exterior from the side edge of the stile. The shaft portion 3a of the lever handle 3 is inserted into the upper portion of the above main body plate portion 10B. An elongated hole 10b long in the longitudinal direction is formed such that the locking plate 10 can be slid in the vertical direction. A through hole 10c for connection with a slide operating member 11 described later is formed on the lower portion side of the locking plate 10. The locking plate 10 is arranged inside the above kicking-out member 4 within the storing concave portion 2c of the above pedestal 2.

On the other hand, in the slide operating member 11 arranged on the outer face side of the above pedestal 2, claw pieces 11a, 11a,—are formed over two vertical stages in both side portions of the slide operating member 11 on its rear face. A connecting shaft 11b is formed in the central portion of the slide operating member 11 on its rear face. Further, a hanging-down click piece 11c is formed on the lower portion side of the slide operating member 11. A window hole 2d is formed in an arranging part in which the slide operating member 11 is arranged in the above pedestal 2. A receiving click portion 12 engaged with the above click piece 11c is formed in the lower portion of the window hole 2d on the side facing the above storing concave portion 2c.

In the attachment of the above slide operating member 11, the slide operating member 11 is held so as not to be pulled out by press-fitting the claw pieces 11a, 11a,—into the window hole 2d while inserting the above click piece 11c into the window hole 2d, and engaging the above claw pieces 11a, 11a,—with a rear face side edge portion of the window hole 2d. The above click piece 11c has a projecting portion 11d in its tip portion. In the above receiving click portion 12, arc concave portions 12a, 12a engaged with the above projecting portion 11d are formed at two vertical stages. When the slide operating member 11 is slid in the vertical direction and is located in its upper and lower side positions, the above receiving click portion 12 is positioned by engaging the projecting portion 11d of the above click piece 11c with each of the arc concave portions 12a, 12a of the receiving click portion 12. The above connecting shaft 11 is inserted into the through hole 10c of the above locking plate 10, and both the connecting shaft 11 and the locking plate 10 are connected to each other by caulking, etc.

On the other hand, a hole portion for locking formed on the window frame side is formed by a hook receiving member 13 having a box body portion 13a of a recessed shape opened on its lower face side.

In the locking, as shown in FIG. 4, when the above slide operating member 11 is lowered in a closing state of the shoji, the above locking plate 10 is lowered and the locking hook portion 10A is engaged with the hole portion for locking in the above hook receiving member 13 so that the locking is performed. The unlocking is performed by raising the above slide operating member 11 and disengaging the slide operating member 11 from the hook receiving member 13.

### THIRD MODE EXAMPLE

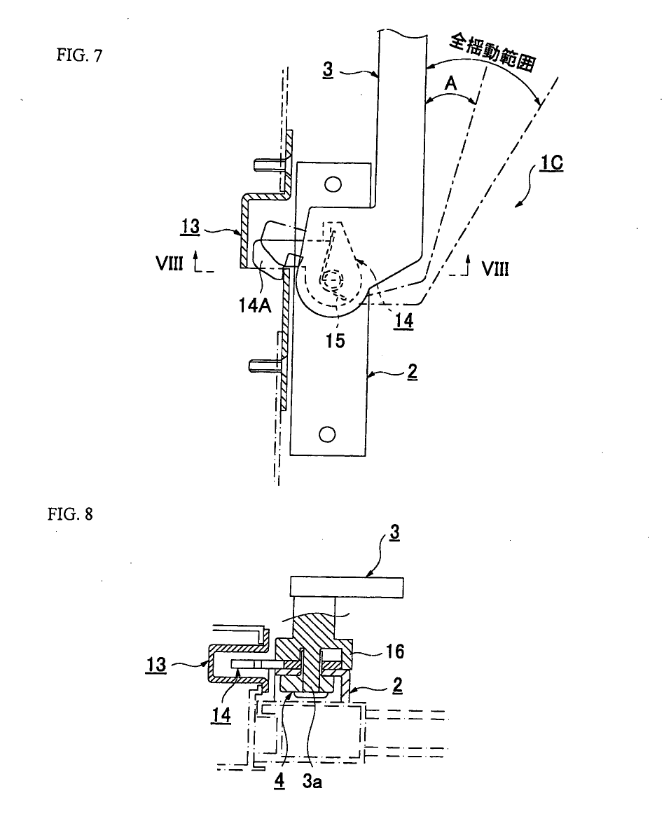

A handle 1C for opening and closing a shoji in accordance with a third mode example will next be described in detail on the basis of FIGS. 7 to 9.

Similar to the above first mode example, the basic structure of the handle 1C for opening and closing a shoji itself is constructed by a pedestal 2, a lever handle 3, a kicking-out member 4 and a spring member 5. The pedestal 2 is fixed to the window frame side stile of a sliding door shoji. The lever handle 3 is attached to this pedestal 2 and is swingably pivoted in a predetermined angular range. The kicking-out member 4 is fixed to a shaft portion 3a of the above lever handle 3, and is projected toward the window frame side by the swinging operation of the above lever handle 3 performed by opening and operating the above sliding door shoji, and assists the opening operation of the shoji by reaction force for kicking-out the window frame. The spring member 5 biases this kicking-out member 4 toward a projection opposing side rotating direction. Accordingly, with respect to the basic structure, the same reference numerals as the first mode example are designated in the drawings and their explanations are omitted.

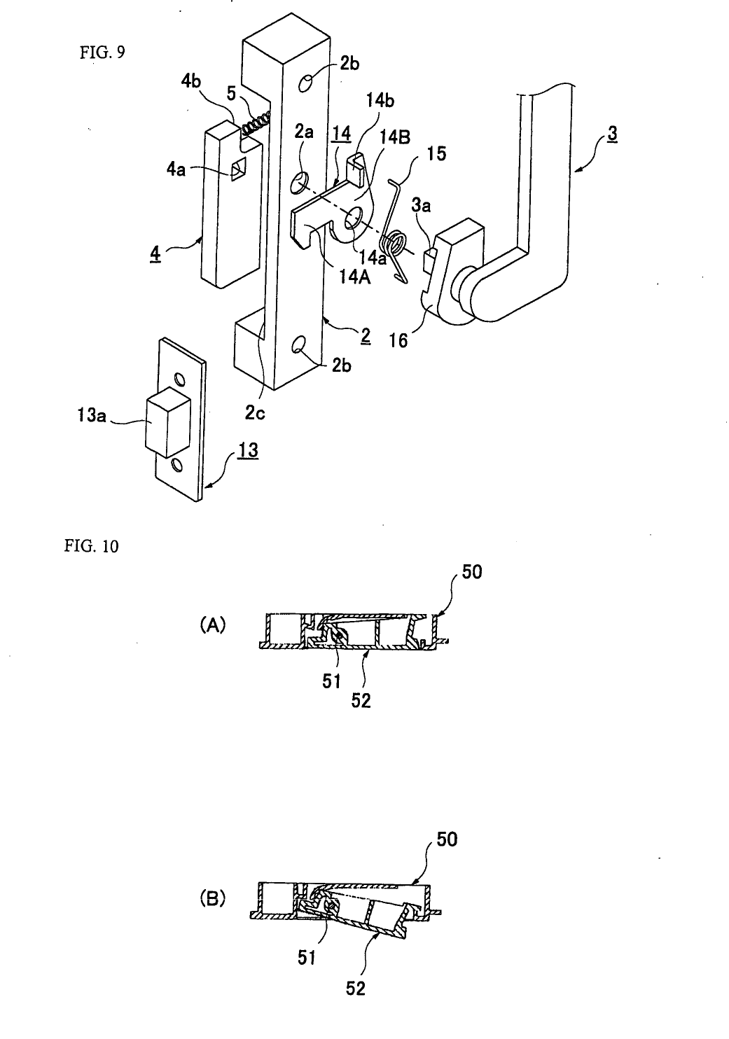

This third mode example differs from the first mode example in the structure of an auxiliary lock. The auxiliary lock is constructed as shown in FIG. 9. Namely, a locking plate 14 is arranged in the above pedestal portion 2. The locking plate 14 is swung by the swinging operation of the above lever handle 3 performed by opening and operating the above sliding door shoji, and has a locking hook portion 14A projected to the exterior from the side edge of the stile. Further, a hole portion for locking able to be engaged with and disengaged from the above locking hook portion 14A by the swinging operation of the above locking plate 14 is arranged on the window frame side.

The handle 1C for opening and closing a shoji will next be described concretely in detail. The above locking plate 14 is a plate member constructed by a main body plate portion 14B and the locking hook portion 14A projected to the exterior from the side edge of the rail. A through hole 14a is formed at the center of the locking plate 14, and the shaft portion 3a of the lever handle 3 is inserted into the through hole 14a. A bent piece portion 14b for engaging one end side of a torsion spring 15 is formed in the upper portion of the locking plate 14. In the illustrated example, the locking plate 14 is arranged in the exterior of the pedestal 2. A cover member 16 for covering the above locking plate 14 is integrally arranged in the shaft portion 3a of the lever handle 3.

If the shaft portion 3a of the lever handle 3 is inserted into a winding hole portion of the torsion spring 15 and is inserted into the through hole 14a of the above locking plate 14 in assembly, this shaft portion 3a is inserted into the shaft hole 2a of the pedestal 2 and is further inserted into the shaft hole 4a of the kicking-out member 4 arranged in the storing concave portion 2c of the pedestal 2. The lever handle 3 and the kicking-out member 4 are then connected to each other by extraction preventing processing such as caulking, etc. The above locking plate 14 is biased by the above torsion spring 15 in the locking side direction at all times. However, the locking hook portion 14A is positioned in the state of a horizontal orientation by hitting the above bent piece portion 14b against an unillustrated projecting portion of the cover member 16.

On the other hand, the hole portion for locking formed on the window frame side is formed by the hook receiving member 13 having a box body portion 13a of a recessed shape opened on its lower face side.

As shown in FIG. 7, when the above lever handle 3 is gripped in the closing state of the shoji and is swung in the opening direction of the shoji in the locking, the locking hook portion 14A of the above locking plate 14 is disengaged from the locking hole portion at the swinging time of a certain extent (angle A) so that the locking is released. When the lever handle 3 is further swung, the kicking-out member 4 is projected on the window frame side, and kicks-out the window frame so that the shoji is initially moved and can be simply opened and operated by small force.

The above auxiliary lock is automatically locked at the closing operation time of the shoji. Namely, the locking plate 14 is biased by the above torsion spring 15 in the locking side direction at all times. When the shoji is closed, the above locking hook portion 14A hits against an edge of the hole portion for locking in the above hook receiving member 13, and then automatically rides across this edge portion and is engaged with the hole portion for locking so that the locking is performed.

### OTHER MODE EXAMPLE

(1) In the above first to third mode examples, the handles 1A, 1B and 1C for opening and closing a shoji in the present invention are described in detail with the sliding door shoji as an example. However, the present invention can be also similarly applied to a raising-lowering shoji.

1. A handle for opening and closing a shoji, comprising a pedestal fixed to the window frame side stile of a sliding door shoji or the lower rail of a raising-lowering shoji; a lever handle attached to this pedestal and swingably pivoted in a predetermined angle range; a kicking-out member fixed to a shaft portion of said lever handle and projected toward the window frame side by the swinging operation of said lever handle performed by opening and operating said sliding door shoji, and assisting the opening operation of the shoji by reaction force for kicking-out the window frame; and a spring member for biasing this kicking-out member toward a projection opposing side rotating direction.

2. The handle for opening and closing a shoji according to claim 1, wherein an auxiliary lock is constructed by arranging a rotatable locking hook piece in said lever handle, and fixing a receiving piece freely engaged with and disengaged from said locking hook piece to the window frame side.

3. The handle for opening and closing a shoji according to claim 1, wherein an auxiliary lock is constructed by arranging a rotatable locking hook piece on the window frame side, and forming a receiving engaging portion freely engaged with and disengaged from said locking hook piece in said lever handle.

4. The handle for opening and closing a shoji according to claim 1, wherein an auxiliary lock is constructed such that a locking plate slidable in the vertical direction and having a locking hook portion projected to the exterior from a side edge of the rail is arranged in said pedestal portion, and a hole portion for locking freely engaged with and disengaged from said locking hook portion by the sliding operation of said locking plate is arranged on the window frame side.

5. The handle for opening and closing a shoji according to claim 1, wherein an auxiliary lock is constructed such that a locking plate swung by the swinging operation of said lever handle performed by opening and operating said sliding door shoji or said raising-lowering shoji, and having a locking hook portion projected to the exterior from a side edge of the rail is arranged in said pedestal portion, and a hole portion for locking freely engaged with and disengaged from said locking hook portion by the swinging operation of said locking plate is arranged on the window frame side.
